(19) United States
(12) Patent Application Publication
(10) Pub. No.: US 2025/0328500 A1
(43) Pub. Date: Oct. 23, 2025

(54) LOOK-TO-SHARE FILE SHARING

(71) Applicant: META PLATFORMS, INC., Menlo Park, CA (US)

(72) Inventor: Chiu Ngok Eric WONG, San Jose, CA (US)

(21) Appl. No.: 17/825,895

(22) Filed: May 26, 2022

(51) Int. Cl. G06F 16/176; G06F 1/16; G06F 3/01; G06V 40/16; H04W 12/06; H04W 12/63

(52) U.S. Cl. CPC G06F 16/176; G06F 1/163; G06F 3/012; G06F 3/013; G06F 3/015; G06V 40/172; H04W 12/06; H04W 12/63

(57) ABSTRACT

Methods, systems, and apparatuses may assist with implementing hands free sharing of files between head-mounted displays or other devices. The devices in proximity may be identified and then eye-gaze tracking information or electromyogram information may be used to select and share files.

### TECHNOLOGICAL FIELD

Exemplary embodiments of this disclosure relate generally to methods, apparatuses, or computer program products for sharing files using head-mounted displays.

### BACKGROUND

Artificial reality is a form of reality that has been adjusted in some manner before presentation to a user, which may include, for example, a virtual reality, an augmented reality, a mixed reality, a hybrid reality, or some combination or derivative thereof. Artificial reality content may include completely computer-generated content or computer-generated content combined with captured (e.g., real-world) content. The artificial reality content may include video, audio, haptic feedback, or some combination thereof, any of which may be presented in a single channel or in multiple channels (such as stereo video that produces a three-dimensional (3D) effect to the viewer). Additionally, in some instances, artificial reality may also be associated with applications, products, accessories, services, or some combination thereof, that are used to, for example, create content in an artificial reality or are otherwise used in (e.g., to perform activities in) an artificial reality. Head-mounted displays (HMDs) including one or more near-eye displays may often be used to present visual content to a user for use in artificial reality applications.

### BRIEF SUMMARY

Disclosed herein are methods, apparatuses, or systems for using hands free sharing of files between head-mounted displays or other devices. In an example, devices in proximity may be identified and then eye-gaze tracking information or electromyogram information may be used to select and share files.

In another example, an apparatus may include one or more processor and memory. The memory may be coupled with the one or more processors and store executable instructions that when executed by the one or more processors cause the apparatus to effectuate operations comprising identifying one or more devices in proximity to the apparatus; determining that device information associated with a remote device of the one or more devices is within an electronic contact list associated with a user profile of the apparatus; displaying device information for a remote device of the one or more devices that are in the electronic contact list; displaying file information associated with one or more files to share with the one or more devices in the electronic contact list; determining facial related movement; based on the facial related movement, selecting the one or more files to facilitate file sharing; and sharing the selected one or more files. Corresponding methods and computer program products may also be provided.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

The summary, as well as the following detailed description, is further understood when read in conjunction with the appended drawings. For the purpose of illustrating the disclosed subject matter, there are shown in the drawings examples of the disclosed subject matter; however, the disclosed subject matter is not limited to the specific methods, compositions, and devices disclosed.

### DESCRIPTION OF THE DRAWINGS

A more detailed understanding may be had from the following description, given by way of example in conjunction with the accompanying drawings wherein:

FIG. 1 illustrates an exemplary head-mounted display (HMD).

FIG. 2 illustrates an exemplary environment for look-to-share file sharing.

FIG. 3 illustrates an exemplary rear view of an HMD.

FIG. 4 illustrates an exemplary method for look-to-share file sharing.

FIG. 5 illustrates an exemplary method for look-to-share file sharing.

FIG. 6 is an exemplary block diagram of a device.

The figures, which are not necessarily to scale, depict various examples for purposes of illustration only. One skilled in the art will readily recognize from the following discussion that alternative examples of the structures and methods illustrated herein may be employed without departing from the principles described herein.

### DETAILED DESCRIPTION

Some examples of the present invention will now be described more fully hereinafter with reference to the accompanying drawings, in which some, but not all examples of the invention are shown. Indeed, various examples of the invention may be embodied in many different forms and should not be construed as limited to the examples set forth herein. Like reference numerals refer to like elements throughout.

It is to be understood that the methods and systems described herein are not limited to specific methods, specific components, or to particular implementations. It is also to be understood that the terminology used herein is for the purpose of describing particular examples only and is not intended to be limiting.

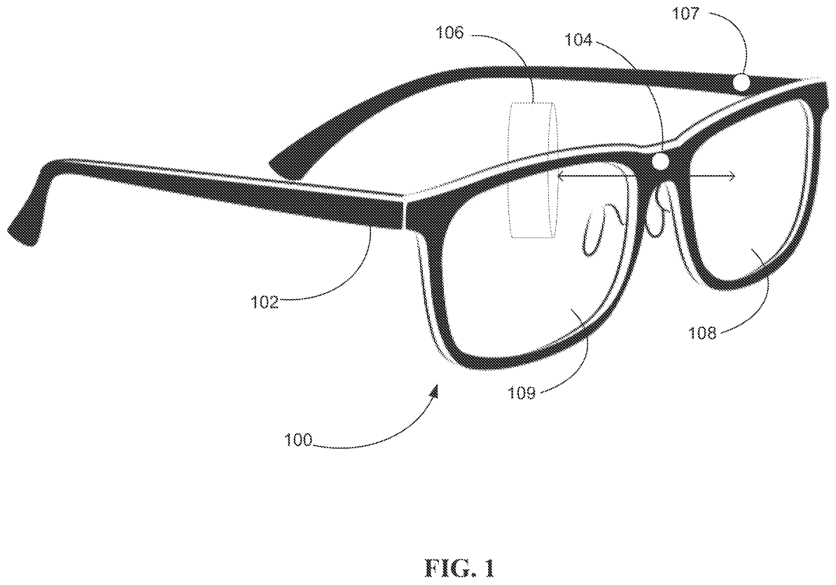

The present disclosure is generally directed to systems and methods for sharing data using head-mounted displays. FIG. 1 illustrates an example head-mounted display (HMD) 100 associated with artificial reality content. HMD 100 may include frame 102 (e.g., an eyeglass frame or enclosure), sensor 104, sensor 107, display 108, or display 109. Display 108 or display 109 may include a waveguide and may be configured to direct images to surface 106 (e.g., user's eye or another structure). In some examples, head-mounted display 100 may be implemented in the form of augmented-reality glasses. Accordingly, display 108 may be at least partially transparent to visible light to allow the user to view a real-world environment through display 108.

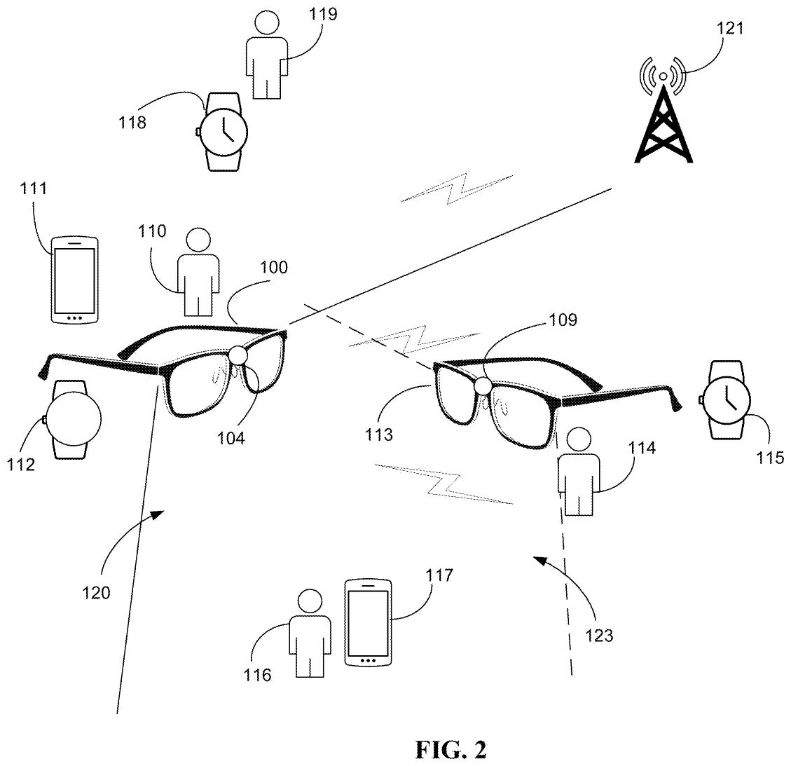

Tracking of surface 106 may be significant for graphics rendering and user peripheral input. HMD 100 design may include sensor 104 (e.g., a front facing camera away from a primary user 110 of FIG. 2) and sensor 107 (e.g., a rear facing camera towards a primary user 110). Sensor 104 or sensor 107 may track movement (e.g., gaze) of eye of primary user 110 or line of sight associated with primary user 110. HMD 100 may include an eye tracking system to track the vergence movement of primary user 110. Sensor 104 may capture images or videos of an area, while sensor 107 may capture video or images associated with surface 106 (e.g., eyes of primary user 110 or other areas of the face). There may be multiple sensors 107 that may be used to detect the reflection off of surface 106 or other movements (e.g., glint or electromyogram (EMG) signals associated with one or more eyes or other parts of the face of primary user 110). Sensor 104 or sensor 107 may be located on frame 102 in different positions. Sensor 104 or sensor 107 may have multiple purposes and may encompass the entire width of a section of frame 102, may be just on one side of frame 102 (e.g., nearest to the eyes of primary user 110), or may be located on display 108.

Herein, glint may refer to light reflected at an angle from a target surface 106 (e.g., one or more eyes). A glint signal may be any point-like response from the eye from an energy input. Examples of energy inputs may be any form of time, space, frequency, phase, or polarized modulated light or sound. Additionally, glint signals may result from a broad area of illumination where the nature of the field of view from the receiving tracking technology may allow detection of point like response from the surface pixels or the volume voxels of the surface 106 (e.g., combination of the detection system with desired artifacts on the surfaces/layers of the eye or within its volume). This combination of illumination and detection field of views coupled with desired artifacts on the layers/volumes may result in point like responses from surface 106 (e.g., glints).

As disclosed, the methods or systems may use voice, electromyogram (EMG) signals from muscles in the face, body movements (e.g., head bowed or extremity movement), or point-of-gaze coordinates produced by an eye-gaze tracking (EGT) system (e.g., using glint tracking). Voice information, EMG information, extremity movement information, and EGT information may be combined or used separately to create one or more options to control sharing of files (e.g., photos, documents, or other data) using HMD 100. Disclosed herein are methods, systems, or apparatuses for determining devices to share and then controlling sharing of files between HMD 100 and other devices (e.g., mobile device 117 or HMD 113 of FIG. 2).

FIG. 2 illustrates an exemplary environment for look-to-share file sharing. Primary user 110 may be associated with HMD 100, mobile device 111, or smartwatch 112. While user 114 may be associated with HMD 113 or smartwatch 115, user 116 may be associated with mobile device 117, and user 119 may be associated with smartwatch 118. Users may be associated with devices based on being linked to user profiles. Base station 121 may be for wide area network access (e.g., cellular system) or local area network access (e.g., Wi-Fi). HMD 100, mobile device 111, smartwatch 112, HMD 113, smartwatch 115, mobile device 117, or smartwatch 118 may be communicatively connected with each other directly (e.g., via Bluetooth or ultra-wideband) or base station 121. Line-of-sight (LOS) area 120 may be based on a determination of the gaze of primary user 110 or video (or image) capture area of sensor 104 of HMD 100. Line-of-sight (LOS) area 123 may be based on a determination of the gaze of user 114 or video (or image) capture area of sensor 109 of HMD 113.

HMD 100 may detect surrounding devices proactively (e.g., sending a wireless signal) or reactively (receiving a wireless signal). HMD 100 may monitor for wireless signals from devices in radio range. HMD 100 may only display (or approve) devices as an option for file sharing that have a wireless signal sensed for a threshold period, have a threshold detected signal strength (e.g., minimum received signal strength), or are in a preferred direction. In an example, although mobile device 117 and mobile device 118 are within range, mobile device 117 may be the only device in the preferred direction (e.g., LOS area 120) and therefore the only device listed (or approved) as an option for file sharing.

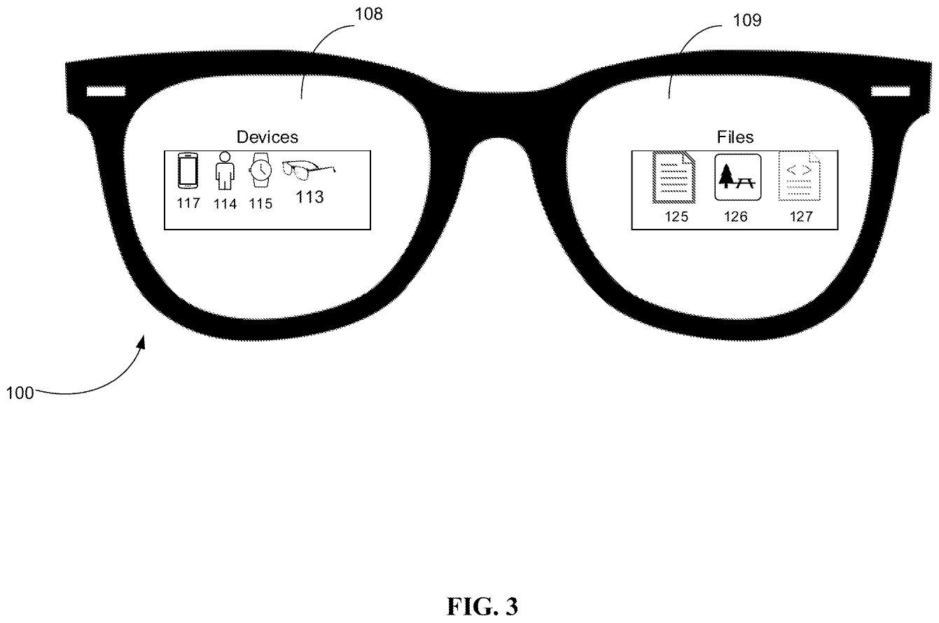

HMD 100 may detect surrounding devices using cameras, such as sensor 104. Sensor 104 may capture one or more people or one or more devices that are in LOS area 120. With reference to captured devices, if an image of one or more of the devices are captured by sensor 104, then HMD 100 may be able to identify mobile device 117, HMD 113, or smartwatch 115 by its features. For example, features may include distinctive shapes or affixed identifiers (e.g., QR codes, barcodes, serial numbers, etc.). With reference to captured people, if an image of one or more people is captured by sensor 104, then HMD 100 may be able to identify user 116 or user 114 by their features, such as object features using object recognition (e.g., facial features using facial recognition or gait recognition). Therefore, selection of devices may be based on facial recognition which may connect known devices associated with the recognized user (e.g., user 114). In an example, when user 114 is identified, then multiple devices based on the user profile of user 114 may be identified. The identified devices may include HMD 113 and smartwatch 115. Therefore, if the icon of user 114 (as shown in FIG. 3) is selected then this may indicate a file transfer to (or from) the available devices associated with user 114 (e.g., HMD 113 and smartwatch 115).

FIG. 3 illustrates an exemplary rear view of HMD 100. HMD 100 may include display 108 or display 109. As shown, display 108 may display a list of devices, such as HMD 113, smartwatch 115, user 114, or mobile device 117. The list of devices may be in an icon form, descriptive text form (e.g., device name or IP address), or another form.

Display 109 may display a list of files that may be shared, such as file 125, file 126, or file 127. File 125 or file 127 may be a document that includes primarily text or the like information while file 126 may be a photo or other image. The list of files may be in an icon form, descriptive text form (e.g., file name), or another form. It is contemplated that display 108 or display 109 may be mirrored or otherwise shown on associated device of primary user 110. The list of devices may be filtered by an electronic contact list (e.g., electronic address book) or the like list of primary user 110.

In an example, EGT or EMG may be used to select one or more files that are shown on display 109 and select one or more devices that are on display 108. EGT and EMG may be calibrated for different eye movements or muscle movements. For example, HMD 113 may be selected by looking at the icon for HMD 113 until a cursor or like indicator is over HMD 113 and quickly blinking twice.

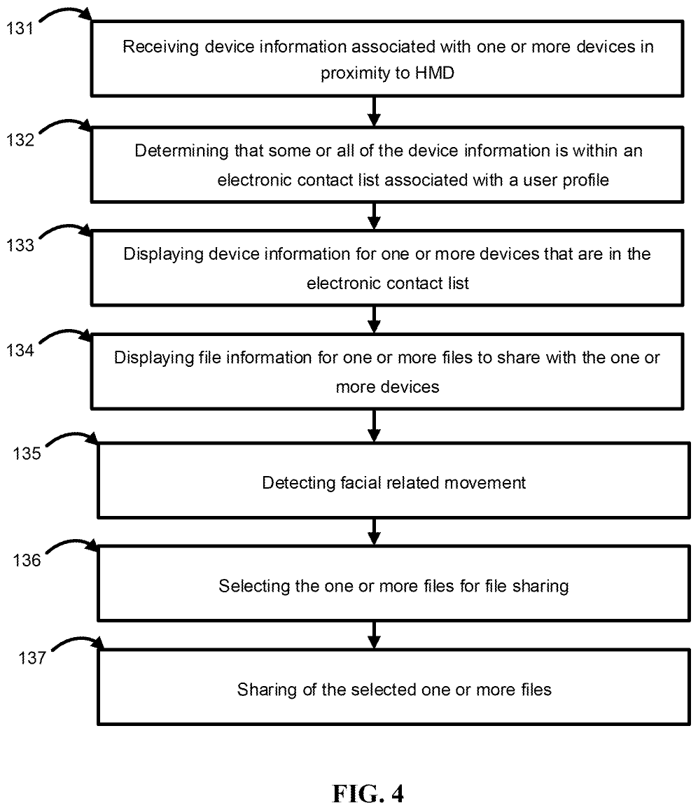

FIG. 4 illustrates an exemplary method for look-to-share file sharing. At block 131, receiving, for example by HMD 100, device information associated with one or more devices in proximity to HMD 100. HMD 100 may be associated with a user profile of primary user 110. The one or more devices may be considered to be in proximity to HMD 100 based on being within radio range of HMD 100, being in LOS area 120 of sensor 104, or other information (e.g., global positioning information). The device information may include device identifiers, device images, device types, device location, or other device information. In this example, HMD 113, smartwatch 115, mobile device 117, and smartwatch 118 may be considered to be in proximity to HMD 100.

At block 132, determining that some or all of the device information is within an electronic contact list associated with the user profile of primary user 110 (e.g., HMD 100). In this example, mobile device 117, HMD 113, and smartwatch 115 may be in the electronic contact list of primary user 110. The electronic contact list may include numerical device identifiers that are linked with usernames or profiles and contact information (e.g., phone numbers, IP addresses, e-mail addresses, medium access control (MAC) addresses, etc.), as shown in Table 1, where George P. Burdell, Georgina D. Burdell and Geordie B. Burdell are fictitious contacts for purposes of illustration.

TABLE 1

| | Contact | | |
|---|---|---|---|
| Contact Name | Number | Devices | Contact Addresses |
| George P. Burdell | 555-5551 | HMD 113, | 10.0.0.1, |
| | | Watch 115 | GPBurdell@email.cu |
| Georgina D. Burdell | 555-5552 | Watch 118 | GDBurdell@email.cu |
| Geordie B. Burdell | 555-5553 | Phone 117 | 10.0.0.2 |

At block 133, displaying, via HMD 100, device information for devices that are in the electronic contact list (e.g., as shown on display 108 of FIG. 3).

At block 134, displaying, via HMD 100, file information for one or more HMD 100 files to share with the devices in the electronic contact list, such as shown on display 109 of FIG. 3. File information may include file types, file identifiers (e.g., file names), or file size (e.g., 2 megabytes), among other things. The one or more HMD 100 files may be located on HMD 100 or remotely stored.

At block 135, detecting facial related movement, such as eye movement of primary user 110. At block 136, based on the facial related movement, selecting the one or more HMD 100 files for file sharing. As disclosed, EGT or EMG may be used to interact with HMD 100. Alternatively, or in addition to facial related movement, voice commands, or detected extremity movements may be used for selection of the one or more HMD 100 files for file sharing. The extremity movements may be detected by sensors, such as cameras, accelerometers, gyroscopes, or the like which may be located in smartwatch 115, HMD 1113, or mobile device 117. In an example, primary user 110 may raise a hand that includes smartwatch 112 or mobile device 111, this action may trigger a photo application on the glasses to send a recently uploaded/taken photo, video, or document to smartwatch 112 or mobile device 111. The trigger may be based on movement detected by a sensor (e.g., gyroscope, accelerometer, or camera).

At block 137, sharing of the selected one or more HMD 100 files with the selected device of the devices that are in the electronic contact list. The one or more HMD 100 files may be sent over a peer-to-peer wireless connection to the selected device. It is contemplated that files may be shared with a plurality of devices simultaneously and HMD 100 may be configured to allow file sharing with devices that are not in the contact list associated with primary user 110. The selected one or more files may be shared based on providing access (e.g., a link to the file) to the selected device without necessarily transmitting the selected one or more files at the time of sharing.

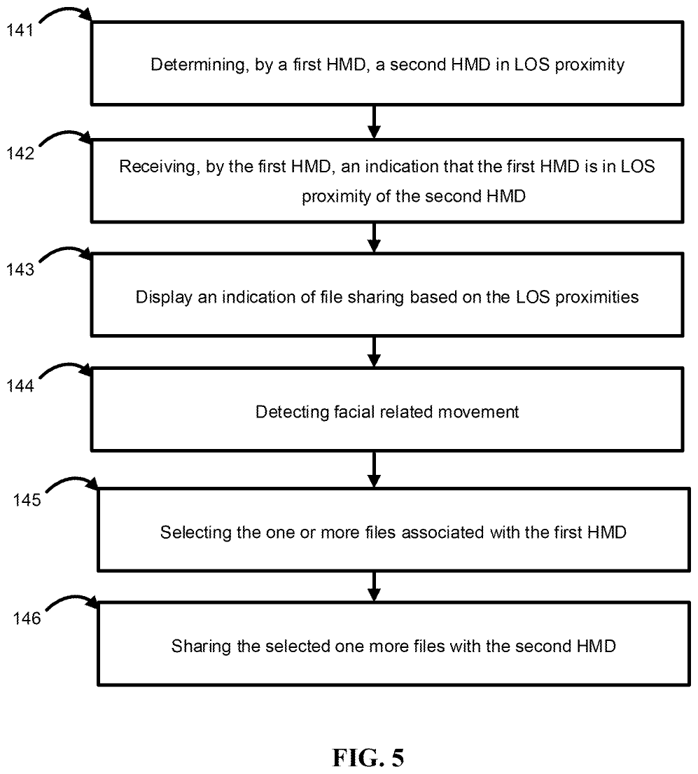

FIG. 5 illustrates an exemplary method for look-to-share file sharing. At block 141, determining, by HMD 100, that HMD 113 is in proximity to HMD 100. HMD 113 may be considered in proximity to HMD 100 based on being in LOS area 120 of sensor 104 for a threshold period. HMD 100 may scan for new devices in LOS area 120 periodically or continuously.

At block 142, receiving, by HMD 100, and indication that HMD 113 is considered to be in proximity to HMD 100. HMD 113 may make the determination that HMD 100 is in proximity to HMD 100 based on HMD 100 being in LOS area 123 of sensor 109. The received indication that HMD 113 is considered to be in proximity to HMD 100 may serve as a form of authentication to proceed with file sharing.

At block 143, based on determining that HMD 113 is in proximity at block 141 and receiving the indication of proximity by HMD 113 at block 142, displaying an indication for file sharing. The indication for file sharing may include a text or icon alert or display of information as shown in FIG. 3. The received indication that HMD 113 is considered to be in proximity to HMD 100 in combination with the determination of step 141 regarding LOS area 120 may trigger alerts for filing sharing, which may include authentication or verification.

At block 144, detecting facial related movement, such as eye movement of primary user 110. At block 145, based on the facial related movement, selecting the one or more HMD 100 files for file sharing.

At block 146, sharing the selected one or more HMD 100 files with HMD 113. The one or more HMD 100 files may be sent over a peer-to-peer wireless connection to HMD 113 or via more wide area network communication methods, such as e-mail, SMS text, file transfer protocol, or the like.

The disclosed approaches for look-to-share file sharing may reduce the friction of file sharing using artificial reality devices. A user may share files without looking for other devices while still being exposed to artificial reality. The disclosed subject matter may also be helpful for individuals that have trouble moving their extremities (e.g., an individual may have some level of paralysis). It is contemplated that the disclosed approaches may be executed on devices of primary user 110, such as mobile device 111 or smartwatch 112 (e.g., file sharing using eye movement or file sharing between devices of a single user profile). The file sharing may be based on receiving an indication that file sharing is authenticated by a remote device (e.g., HMD 113) recognizing (e.g., through object recognition) another device (e.g., HMD 100) in proximity.

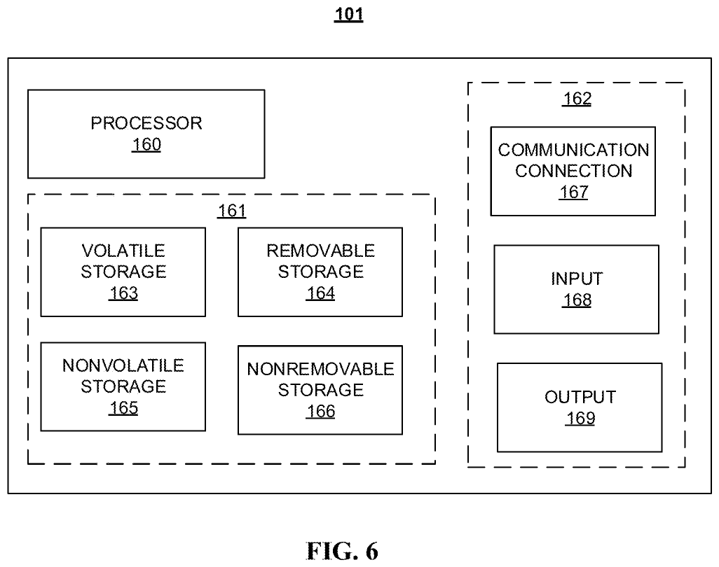

FIG. 6 is an exemplary block diagram of a device, such as HMD 100, mobile device 111, smartwatch 112, or base station 121, among other devices. In an example, HMD 100 may include hardware or a combination of hardware and software. The functionality to facilitate telecommunications via a telecommunications network may reside in one or combination of devices. A device may represent or perform functionality of one or more devices, such as a component or various components of a cellular broadcast system wireless network, a processor, a server, a gateway, a node, a gaming device, or the like, or any appropriate combination thereof. It is emphasized that the block diagram depicted in FIG. 6 is exemplary and not intended to imply a limitation to a specific implementation or configuration. Thus, HMD 100, for example, may be implemented in a single device or multiple devices (e.g., single server or multiple servers, single gateway or multiple gateways, single controller or multiple controllers). Multiple network entities may be distributed or centrally located. Multiple network entities may communicate wirelessly, via hardwire, or any appropriate combination thereof.

HMD 100 may include a processor 160 or a memory 161, in which the memory may be coupled with processor 160. Memory 161 may include executable instructions that, when executed by processor 160, cause processor 160 to effectuate operations associated with look-to-share file sharing, or other subject matter disclosed herein. Memory 161 may include volatile storage 163, nonvolatile storage 165, removable storage 164, or nonremovable storage 166.

In addition to processor 160 and memory 161, HMD 100 may include an input/output system 162. Processor 160, memory 161, or input/output system 162 may be coupled together (coupling not shown in FIG. 6) to allow communications between them. Each portion of HMD 100 may include circuitry for performing functions associated with each respective portion. Thus, each portion may include hardware, or a combination of hardware and software. Input/output system 162 may be capable of receiving or providing information from or to a communications device or other network entities configured for telecommunications. For example, input/output system 162 may include a wireless communication (e.g., Wi-Fi, Bluetooth, or 5G) card. Input/output system 162 may be capable of receiving or sending video information, audio information, control information, image information, data, or any combination thereof. Input/output system 162 may be capable of transferring information with HMD 100. In various configurations, input/output system 162 may receive or provide information via any appropriate means, such as, for example, optical means (e.g., infrared), electromagnetic means (e.g., radio frequency (RF), Wi-Fi, Bluetooth), acoustic means (e.g., speaker, microphone, ultrasonic receiver, ultrasonic transmitter), or a combination thereof. In an example configuration, input/output system 162 may comprise a Wi-Fi finder, a two-way GPS chipset or equivalent, or the like, or a combination thereof.

Input/output system 162 of HMD 100 also may include a communication connection 167 that allows HMD 100 to communicate with other devices, network entities, or the like. Communication connection 167 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 162 also may include an input device 168 such as keyboard, mouse, pen, voice input device, or touch input device. Input/output system 162 may also include an output device 169, such as a display, speakers, or a printer.

Processor 160 may be capable of performing functions associated with telecommunications, such as functions for processing broadcast messages, as described herein. For example, processor 160 may be capable of, in conjunction with any other portion of HMD 100, determining a type of broadcast message and acting according to the broadcast message type or content, as described herein.

Memory 161 of HMD 100 may include a storage medium having a concrete, tangible, physical structure. As is known, a signal does not have a concrete, tangible, physical structure. Memory 161, as well as any computer-readable storage medium described herein, is not to be construed as a signal. Memory 161, as well as any computer-readable storage medium described herein, is not to be construed as a transient signal. Memory 161, as well as any computer-readable storage medium described herein, is not to be construed as a propagating signal. Memory 161, as well as any computer-readable storage medium described herein, is to be construed as an article of manufacture.

Herein, a computer-readable storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable storage medium may be volatile 163, non-volatile 165, or a combination of volatile and non-volatile, where appropriate.

While the disclosed systems have been described in connection with the various examples of the various figures, it is to be understood that other similar implementations may be used or modifications and additions may be made to the described examples of look-to-share file sharing, among other things as disclosed herein. For example, one skilled in the art will recognize that look-to-share file sharing, among other things as disclosed herein in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure—look-to-share file sharing—as illustrated in the Figures, specific terminology is employed for the sake of clarity. The claimed subject matter, however, is not intended to be limited to the specific terminology so selected.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another example includes from the one particular value or to the other particular value. Similarly, when values are expressed as approximations, by use of the antecedent “about,” it will be understood that the particular value forms another example. All ranges are inclusive and combinable. It is to be understood that the terminology used herein is for the purpose of describing particular aspects only and is not intended to be limiting.

This written description uses examples to enable any person skilled in the art to practice the claimed subject matter, including making and using any devices or systems and performing any incorporated methods. Other variations of the examples are contemplated herein. It is to be appreciated that certain features of the disclosed subject matter which are, for clarity, described herein in the context of separate examples, may also be provided in combination in a single example. Conversely, various features of the disclosed subject matter that are, for brevity, described in the context of a single example, may also be provided separately or in any sub-combination. Further, any reference to values stated in ranges includes each and every value within that range. Any documents cited herein are incorporated herein by reference in their entireties for any and all purposes.

The scope of this disclosure encompasses all changes, substitutions, variations, alterations, and modifications to the examples described or illustrated herein that a person having ordinary skill in the art would comprehend. The scope of this disclosure is not limited to the examples described or illustrated herein. Moreover, although this disclosure describes and illustrates respective examples herein as including particular components, elements, feature, functions, operations, or steps, any of these examples may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular examples as providing particular advantages, particular examples may provide none, some, or all of these advantages.

Methods, systems, and apparatuses, among other things, as described herein may provide for look-to-share file sharing. A method, system, computer readable storage medium, or apparatus may provide for detecting an indication of a command associated with a user of the HMD, wherein the indication of the command is for sharing data with one or more devices; in response to the indication of the command, detecting one or more devices in proximity to the HMD, wherein proximity is indicated by: being, within a threshold period, in line of sight (e.g., using UWB) of one or more cameras of the HMD, or being within a threshold range of a wireless signal that is based on signal strength; determining whether a recognized device of the one or more devices is within a contact list associated with a user of the HMD; determining whether a recognized user is within a contact list connected with a facial (or gait) recognition database; selecting, based on using EMG (e.g., EMG click-mouse click), gaze, or voice, the one or more devices; receiving an authorization to send data from the HMD to the one more devices that are selected; and sending the data to the one or more devices. If the recognized device is within the contact list, then use wide area network communications or local area network communications to reach the recognized device. If the recognized device is within the contact list, then devices associated with the recognized user in a list of the one or more devices to share may be included. The command may be detected based on electromyography (EMG), EGT, extremity movements, or voice. The data may include a photo, video, still images, or other files. All combinations in this paragraph (including the removal or addition of steps) are contemplated in a manner that is consistent with the other portions of the detailed description.

Methods, systems, and apparatuses, among other things, as described herein may provide for look-to-share file sharing. A method, system, computer readable storage medium, or apparatus may provide for receiving device information associated with one or more devices in proximity to the apparatus or identifying one or more devices in proximity to the apparatus; determining that device information associated with a remote device (e.g., not integrated into the apparatus) of the one or more devices is within an electronic contact list associated with a user profile of the apparatus; displaying device information for a remote device of the one or more devices that are in the electronic contact list; displaying file information for one or more files to share with the one or more devices in the electronic contact list; detecting facial related movement; based on the facial related movement, selecting the one or more files for file sharing; and sharing the selected one or more files. The apparatus may be a mobile device. Mobile device may include a HMD, smartwatch, smart phone, laptop, or the like. The method, system, computer readable storage medium, or apparatus may provide for receiving an indication that the one or more devices are within a line-of-sight area associated with the apparatus; and determining that the one or more devices are in proximity to the apparatus, based on the indication that the one or more devices are within the line-of-sight area. The method, system, computer readable storage medium, or apparatus may provide for using facial recognition to identify the one or more devices. The method, system, computer readable storage medium, or apparatus may provide for using EMG information or EGT information. The sharing may be based on receiving an indication that file sharing is authenticated by the remote device. All combinations in this paragraph and the previous paragraph (including the removal or addition of steps) are contemplated in a manner that is consistent with the other portions of the detailed description.

1. A head-mounted device, comprising:
one or more processors; and
memory coupled with the one or more processors, the memory storing executable instructions that when executed by the one or more processors cause the head-mounted device to:
receive an identification, based on object recognition, of another user in proximity to a user of the head-mounted device;
determine that the other user is on an approved contact list for the user of the head-mounted device;
identify one or more devices in proximity to the head-mounted device, wherein the one or more devices in proximity comprise a remote device distinct from the head-mounted device;
in accordance with determining that the remote device is associated with the other user, display, at the head-mounted device, first device information associated with the remote device and second device information associated with an additional device associated with the other user;
after determining that the remote device and the additional device associated with the other user are authorized for file sharing, display file information associated with one or more files available for sharing with the remote device and/or the additional device;
receive information indicating a facial related movement from the user of the head-mounted device, the facial related movement identifying selected files of the one or more files available for sharing; and
in accordance with receiving an indication that the other user accepts receipt of the selected files, initiate sharing of the selected files with the remote device and the additional device.

2. The head-mounted device of claim 1, wherein the remote device and/or the additional device is not in the approved contact list associated with the user.

3. The head-mounted device of claim 1, wherein the displaying of the first and second device information includes options for selecting one or more respective devices for sharing files.

4. The head-mounted device of claim 1, wherein at least one of the remote device and the additional device is identified based on object recognition.

5. The head-mounted device of claim 1, wherein when the one or more processors further execute the executable instructions, the head-mounted device is caused to:
utilize electromyography information to select the selected files from among the one or more files to facilitate the file sharing.

6. The head-mounted device of claim 1, wherein when the one or more processors further execute the executable instructions, the head-mounted device is caused to:
utilize eye-gaze tracking information to select the selected files from among the one or more files to facilitate the file sharing.

7. The head-mounted device of claim 1, wherein the object recognition used to identify the other user includes gait recognition.

8. A method comprising:
receiving an identification, based on object recognition, of another user in proximity to a user of a head-mounted device;
determining that the other user is on an approved contact list for the user of the head-mounted device;
identifying one or more devices in proximity to the head-mounted device, wherein the one or more devices in proximity comprise a remote device distinct from the head-mounted device;
in accordance with determining that the remote device is associated with the other user, displaying, at the head-mounted device, first device information associated with the remote device and second device information associated with an additional device associated with the other user;
after determining that the remote device and the additional device associated with the other user are authorized for file sharing, displaying file information associated with one or more files available for sharing with the remote device and/or the additional device;
receive information indicating a facial related movement from the user of the head-mounted device, the facial related movement identifying selected files of the one or more files available for sharing; and
in accordance with receiving an indication that the other user accepts receipt of the selected files, initiate sharing of the selected files with the remote device and the additional device.

9. The method of claim 8, wherein the remote device comprises a smartwatch or a head-mounted display.

10. The method of claim 8, wherein the remote device and/or the additional device not in the contact list associated with the user.

11. The method of claim 8, wherein the object recognition comprises gait recognition.

12. The method of claim 8, further comprising:
utilizing electromyography information to select the one or more files to facilitate the file sharing.

13. The method of claim 8, further comprising:
utilizing eye-gaze tracking information to select the one or more files to facilitate the file sharing.

14. The method of claim 8, further comprising:
enabling the sharing based on receiving an indication that the file sharing is authenticated by the remote device.

15. A non-transitory computer readable storage medium comprising instructions that, when executed, cause:
receiving an identification, based on object recognition, of another user in proximity to a user of a head-mounted device;
determining, based on features of the other user, that the other user is on an approved contact list for the user of the head-mounted device;
identifying one or more devices in proximity to the head-mounted device, wherein the one or more devices in proximity comprise a remote device distinct from the head-mounted device;
in accordance with determining that the remote device is associated with the other user, displaying, at the head-mounted device, first device information associated with the remote device and second device information associated with an additional device associated with the other user;
after determining that the remote device and the additional device associated with the other user are authorized for file sharing, displaying file information associated with one or more files available for sharing with the remote device and/or the additional device;
receive information indicating a facial related movement from the user of the head-mounted device, the facial related movement identifying selected files of the one or more files available for sharing; and
in accordance with receiving an indication that the other user accepts receipt of the selected files, initiate sharing of the selected files with the remote device and the additional device.

16. The computer readable storage medium of claim 15, wherein the remote device and/or the additional device not in the contact list associated with the user.

17. The computer readable storage medium of claim 15, wherein the remote device and/or the additional device is not in the approved contact list associated with the user.

18. The computer readable storage medium of claim 15, wherein at least one of the remote device and the additional device is identified based on object recognition.

19. The computer readable storage medium of claim 15, wherein the instructions, when executed, further cause:
utilizing electromyography information to select the one or more files to facilitate the file sharing.

20. The computer readable storage medium of claim 15, wherein the instructions, when executed, further cause:
utilizing eye-gaze tracking information to select the one or more files to facilitate the file sharing.
